(19) United States
(12) Patent Application Publication
(10) Pub. No.: US 2026/0329234 A1
(43) Pub. Date: Oct. 22, 2026

(54) TIMEKEEPING OF A CLOCK DEVICE

(71) Applicant: ADTRAN Networks SE, Meiningen (DE)

(72) Inventor: Alon STERN, Haifa (IL)

(21) Appl. No.: 19/245,586

(22) Filed: Jun. 23, 2025

(30) Foreign Application Priority Data
Jun. 25, 2024 (EP) 24184306.9

(51) Int. Cl. G04G 7/00; G05B 13/02

(52) U.S. Cl. CPC G04G 7/00; G05B 13/0265

(57) ABSTRACT

There is provided a technique of timekeeping of a clock device. The technique comprises: in the presence of an inbound reference timing signal, continuously tuning during a learning period an adaptive model comprising a phase-frequency (PF) adaptive sub-model and phase-frequency-drift (PFD) adaptive sub-model; selecting a sub-model to use its last before holdover (LBH) estimates for correcting an output timing signal, the selection provided in accordance with the relationship between duration of the learning period and a learning threshold characterizing the oscillator and in the presence of the reference timing signal (or responsive to the lost thereof). During a holdover continuously generating a corrected output timing signal using the LBH estimates provided by the selected sub-model. The technique further comprises defining a first (OD1) and a second (OD2) optimal duration thresholds informative of the optimal duration of tuning, respectively, PF adaptive algorithm and PFD adaptive algorithm; and tuning the sub-models accordingly.

### CROSS-REFERENCES TO RELATED APPLICATIONS

The present application claims benefit from EP Patent Application No. 24184306.9 filed on Jun. 25, 2024, and incorporated hereby by reference in its entirety.

### TECHNICAL FIELD

The presently disclosed subject matter relates to the field of synchronization of clock devices in time-aware networks and/or of time-sensitive applications and, more particularly, to maintaining precise time parameters of a clock device in the absence of a time reference.

### BACKGROUND

Proper operation of a time-aware network (e.g. a telecommunication network, a distributed computer system, etc.) and/or time-sensitive applications (e.g. audio, video, time-sensitive control, etc.) requires time of day, phase and frequency synchronization between various clocks therein. Synchronization can be achieved, for example, by exchanging timing information (time-transfer) across the network in accordance with time-transfer protocols (e.g. IEEE 1588 Precision Time Protocol (PTP), Network Time Protocol (NTP), etc).

Operating a typical time-aware network and/or a time-sensitive application is based on synchronizing clock devices with a reference clock. FIG. 1 schematically illustrates a non-limiting example of a time-aware network 100, including a plurality of clock devices (referred to hereinafter also as clock nodes) denoted as 11-1-11-6 and implementing a time-transfer protocol as known in prior art. The exemplary network 100 is a timing distribution network and can operate on top of a packet-compatible communication network (not shown) which comprises a plurality of network nodes organized in ring, bus, tree, star, or mesh topologies, or a combination of different topologies. Clock nodes can correspond to network nodes of the underlying data network and can constitute parts of the respective network nodes.

Clock nodes 11-2-11-4 are operatively connected to the clock node 11-1 via respective clock ports (not shown). Clock node 11-1 is configured to be the source of synchronization data in the network and to serve as a primary reference time clock (PRTC) node receiving reference timing signal from GNSS (Global Navigation Satellite Systems) and providing the reference timing signals to the clock nodes 11-2-11-4. Clock node 11-4 is configured as a boundary clock node receiving PTP-based timing reference signal and providing, in turn, reference timing signals to nodes 11-5 and 11-6.

Thus, the reference clock (e.g. primary reference time clock such as a GNSS and/or atomic clock, PTP reference clock, etc.) provides reference timing signals to the respective clock devices. Each given clock device generates a timing signal in accordance with the received reference timing signals.

However, in some circumstances (e.g. source failures or blockages, network congestion, network fault, etc.) a given clock device can temporarily lose the reference timing signal and enter into a time holdover period (referred to hereinafter also as holdover) characterized by the absence of an incoming time reference. The holdover period can last from a few seconds to several days or more.

In the absence of an incoming reference signal, the clock device continues to generate a timing signal using the last valid reference timing data received before the loss of the reference signal. The clock device generates the timing signal with the help of a local oscillator (free running or controlled using a feedback loop). The local oscillator can be an internal oscillator of the clock device. Some clock devices can use external frequency reference received via data network interface(s) or dedicated frequency interface(s). For example, ePRC (Enhanced Primary Reference Clock) can serve as an external frequency source.

However, the oscillators can be instable due to various reasons as, for example, temperature fluctuations and/or ageing effects. Thus, there is a need for precise timekeeping of a clock device, thereby retaining its accurate frequency and phase offsets during the holdover.

Problems of precise timekeeping in the absence of time reference have been recognized in the conventional art and various techniques have been developed to provide solutions, for example:

US Patent publication No. 2023/0315025 discloses a technique of predictive clock modelling. The method includes collecting a characteristic of a first clock disposed therein via a first node; collecting a characteristic of a second clock disposed therein via a second node; receiving an instance of time of the first clock via the first node and receiving an instance of time of the second clock via the second node. The method further includes causing to determine a time offset and/or frequency offset between the first and second clock via a model based on the collected characteristic and the received instance of time from each of the first and second nodes; and transmitting an indication of the determined time offset and/or frequency offset output from the model to the second node.

US Patent Publication No. 2021/0266086 discloses a technique of improving phase clock performance for a system embedded with GNSS receiver. The technique includes storing a phase history of the GNSS receiver output; determining an expected value of phase of the GNSS receiver output based on the phase history; and, responsive to a degradation of the GNSS receiver output, adjusting the GNSS receiver output utilizing the expected value of phase. The systems and method can further include, responsive to degradation being a loss of the GNSS receiver output, utilizing a holdover output from a physical frequency reference and with a phase adjusted based on the expected value of phase, and, responsive to the variation, utilizing the phase history to re-generate the GNSS receiver output for performance enhancement.

US Patent Publication No. 2009/0278616 discloses a method and apparatus for correcting oscillator frequency drift due to crystal aging. Correction signals that reflect a difference between an oscillator timing signal and a reference timing signal over a reference timing signal interval are modelled so that auxiliary correction signals can be generated in the event of loss of the reference timing signal. A temperature curve is generated to model how temperature variation impacts oscillator frequency drift. A rate of frequency drift due to crystal aging is also determined. During loss of a reference timing signal, auxiliary correction signals can be generated to maintain the oscillator at a desired frequency until the reference timing signal becomes available again.

US Patent Publication No. 2009/0167443 discloses a system and method for generating a highly stable holdover clock utilizing an integrated circuit and an external Oven Controlled Crystal Oscillator (OCXO). The integrated circuit comprises an input reference clock receiver, a phase and frequency detector that generates an error signal between the input reference clock signal and a feedback clock signal, a data storage block that stores model parameters to predict frequency variations of the OCXO, an adaptive filtering module that includes a digital loop filter and algorithms for updating the model parameters and predicting frequency variations based on the model, a switch that enables the system to operate in normal or holdover mode, a digitally controlled oscillator, and a feedback divider.

U.S. Pat. No. 7,424,069 discloses a reference timing signal apparatus with a phase-locked loop having a computer algorithm which adaptively models the multiple frequencies of an oscillator following a training period. The oscillation frequency of the oscillator is controlled in response to a phase detector output. The computer algorithm processes the control signal applied to the oscillator. The computer algorithm updates the characteristics of the model relating to the aging and temperature of the oscillator, using for example, a Kalman filter as an adaptive filter. By the algorithm, the subsequent model predicts the future frequency state of the oscillator on which it was trained. The predicted frequency of the model functions as a reference to correct the frequency of the oscillator if no input reference timing signal is available. In the case of using pre-processing infinite impulse response filters (IIRFs) before the adaptive processor, the time delay caused by the filters are compensated after the adaptive processor. Without pre-processing IIRFs, aging and temperature update rates are adaptively controlled by dynamically changing the rates depending upon the loop condition to achieve a wider tracking bandwidth. With the model updating algorithm, oscillators of low stability performance may be used as cellular base station reference oscillator.

The references cited above teach background information that may be applicable to the presently disclosed subject matter. Therefore, the full contents of these publications are incorporated by reference herein where appropriate for appropriate teachings of additional or alternative details, features and/or technical background.

### GENERAL DESCRIPTION

A state of an oscillator can be characterized using three deterministic variables: x(t), informative of the time/phase difference between the oscillator's output and that of a reference device (or a previous measurement); y(t), informative of the frequency difference thereof; and d(t), informative of the change rate (drift) in frequency.

The state of an oscillator can be deduced with the help of adaptive models applied to respective measurements. Non-limiting examples of such models are disclosed in the article by J. Levine (J. Levine. The statistical modeling of atomic clocks and the design of time scales, Rev Sci Instrum. 83, 021101 (2012)) and the article of L. Breakiron (L. Breakiron. A Comparative Study of Clock Rate and Drift Estimation. NASA. Goddard Space Flight Center, The 25th Annual Precise Time and Time Interval (PTTI) Applications and Planning Meeting, 1994). These articles are incorporated herein by reference.

An adaptive model estimates the state of the oscillator in the presence of the reference timing signal. When the reference timing signal is lost, the last estimates of the state are usable for correcting an output timing signal of the clock device. It is noted that when the reference timing signal is back, the adaptive model may need to re-start learning (tuning) if the holdover was long enough (e.g. several hours for PRTC devices, several days for ePRTC (Enhanced Primary Reference Time Clock) devices), etc.

The known in the conventional art methods of estimating the state variables either disregard frequency offset drift (e.g. using 2-variables adaptive models such as first order polynomial fitting approach, phase-frequency Kalman filter model, etc.) or attempt to unconditionally jointly estimate the frequency offset and its drift (e.g. using 3-variables adaptive models such as second-order polynomial fitting approach, phase-frequency-drift Kalman filter model, etc.).

Other known in the conventional art methods teach dynamic switching between a 2-variables adaptive model and 3-variables adaptive model depending on performance metrics of the timing signal (e.g. LI XIALI ET AL: “A Multi-model Kalman Filter Clock Synchronization Algorithm based on Hypothesis Testing in Wireless Sensor Networks”, Proceedings of the 2nd International Conference on Electronic and Mechanical Engineering and Information Technology (2012)).

Nowadays, advancing network architectures and services elevate synchronization demands. For example, as ITU-T standard G.8272.1 requires holdover time accuracy of ePRTC to be within 100 ns of UTC (Coordinated Universal Time) for up to 40 days, depending on the learning period obtained when the ePRTC was locked to UTC prior to the holdover.

The inventor has recognized and appreciated that enduring holdover stability can be achieved by correcting the output timing signal using a combined adaptive model. Namely, the inventor has proposed to use estimates by phase-frequency (2-variables) adaptive sub-model when a duration of a learning period is less than a certain learning threshold, and, alternatively, to use estimates by a phase-frequency-drift (3variables) adaptive sub-model when/if the duration of the learning period exceed the certain learning threshold, thereby enabling the precise timekeeping. The learning threshold can be predefined in accordance with known characteristics of the oscillator or can be defined during the oscillator's operation.

Unless specifically stated otherwise, throughout the specification the term “learning period” refers to a period of tuning at least one of the above adaptive sub-models in the present of the reference timing signal. It is noted that the adaptive model is considered to be tuning if at least one of its adaptive sub-models is undergoing tuning and is providing estimates of a state of the oscillator, the sub-models can be tuned sequentially or, at least partly, in parallel.

The proposed approach is applicable for a holdover period of a free running oscillator. Likewise, the approach is applicable for a controlled oscillator when operating with and/or without reference timing signal.

In accordance with certain aspects of the presently disclosed subject matter, there is provided a method of timekeeping of a clock device operating in conjunction with an oscillator. The method comprises: in the presence of an inbound reference timing signal, continuously tuning during a learning period an adaptive model comprising a phase-frequency (PF) adaptive sub-model using a PF adaptive algorithm and a phase-frequency-drift (PFD) adaptive sub-model using a PFD adaptive algorithm, selecting a sub-model to use for correcting an output timing signal during a holdover, the selection provided in accordance with the relationship between duration of the learning period and a learning threshold characterizing the oscillator. Selecting the adaptive sub-model is provided in the presence of the inbound reference timing signal or responsive to the loss of the inbound reference timing signal. During the holdover period the method further comprises continuously generating a corrected output timing signal using the last before holdover (LBH) estimates provided by the selected sub-model.

In accordance with further aspects of the presently disclosed subject matter, the method further comprises using LBH estimates of phase and frequency of the oscillator provided by PF adaptive sub-model when a duration of the learning period is less than the learning threshold; and using LBH estimates of phase, frequency and drift of the oscillator provided by PFD adaptive sub-model when the duration of the learning period exceeds the learning threshold.

In accordance with further aspects and, optionally, in combination with other aspects of the presently disclosed subject matter, the learning threshold can be predefined with the help of simulation using known characteristics of the oscillator and be pre-configured for the clock device. Alternatively or additionally, the learning threshold can be calculated based on historical data informative of phase and frequency changes of the oscillator during its operation in the presence of inbound reference timing signal and be configured during operation of the clock device in the presence of the inbound reference timing signal.

In accordance with further aspects and, optionally, in combination with other aspects of the presently disclosed subject matter, the oscillator operating in conjunction with the clock device can be an internal oscillator of the clock device or an external oscillator. Further, the oscillator operating in conjunction with the clock device can be a free running oscillator or a controlled oscillator.

In accordance with further aspects and, optionally, in combination with other aspects of the presently disclosed subject matter, the PF adaptive sub-model can use a 1st order polynomial fitting estimations algorithm or a phase-frequency Kalman filter algorithm and PFD adaptive sub-model can use a 2nd order polynomial fitting estimations algorithm or a phase-frequency-drift Kalman filter algorithm. PF adaptive sub-model and PFD adaptive sub-model can be based on the same or on different kinds of algorithms.

In accordance with further aspects and, optionally, in combination with other aspects of the presently disclosed subject matter, the method can further comprise defining a first optimal duration (OD1) threshold informative of the optimal duration of tuning a phase-frequency adaptive algorithm used in PF adaptive sub-model and/or a second optimal duration (OD2) threshold informative of the optimal duration of a phase-frequency-drift adaptive algorithm used in PFD adaptive sub-model.

In accordance with further aspects and, optionally, in combination with other aspects of the presently disclosed subject matter, the method can further comprise: storing values informative of time/phase and frequency restored during operating the clock device in the presence of the reference timing signal thereby giving rise to past timing data; obtaining a plurality of sets of the past timing data, different sets corresponding to different history lengths; applying one or more phase-frequency adaption algorithms and/or one or more phase-frequency-drift adaption algorithm for each set of the past timing data; calculating, for each adaptive algorithm, for each history length and for every timestep, residuals informative of deviations between respective past timing data and predictions by the adaptive algorithms; and performing statistical analyses over the residuals to identify an optimal duration of learning period for each of the adaptive algorithms, thereby defining at least one of the learning threshold, OD1 threshold and OD2 threshold.

In accordance with further aspects and, optionally, in combination with other aspects of the presently disclosed subject matter, the method can further comprise:
when learning period is less than OD1 threshold, using the estimates by the PF sub-model that is tuned based on the entire available learning history;
when learning period exceeds OD1 threshold but is less than the learning threshold, using the estimates by the PF sub-model that is tuned based on the learning history corresponding, at each timestep, to data in a backward window with duration OD1;
when learning period exceeds the learning threshold but is less than OD2 threshold, using the estimates by the PFD sub-model that is tuned based on the entire available learning history; and
when learning period exceeds OD2 threshold but exceeds the learning threshold, using the estimates by the PFD sub-model that is tuned based on the learning history corresponding, at each timestep, to data in a backward window with duration OD2.

In accordance with other aspects of the presently disclosed subject matter, there is provided a clock device configured to perform timekeeping in accordance with the method above.

In accordance with other aspects of the presently disclosed subject matter, there is provided a computer program product implemented on a non-transitory computer usable medium having computer readable program code embodied therein to cause the computer to perform the method above.

Among the advantages of certain embodiments of the presently disclosed subject matter is enabling the enhanced accuracy of ePRTC clock devices during extended holdover period. Among further advantages is achieving enhanced holdover precision of various range of oscillators usable for PRTC products, PTP boundary clocks, PTP slaves, NTP slaves, etc.

### BRIEF DESCRIPTION OF THE DRAWINGS

To understand the invention and to see how it can be carried out in practice, embodiments will be described, by way of non-limiting examples, with reference to the accompanying drawings, in which:

FIG. 1 illustrates a generalized schematic architecture of an exemplary timing distribution network as known in prior art;

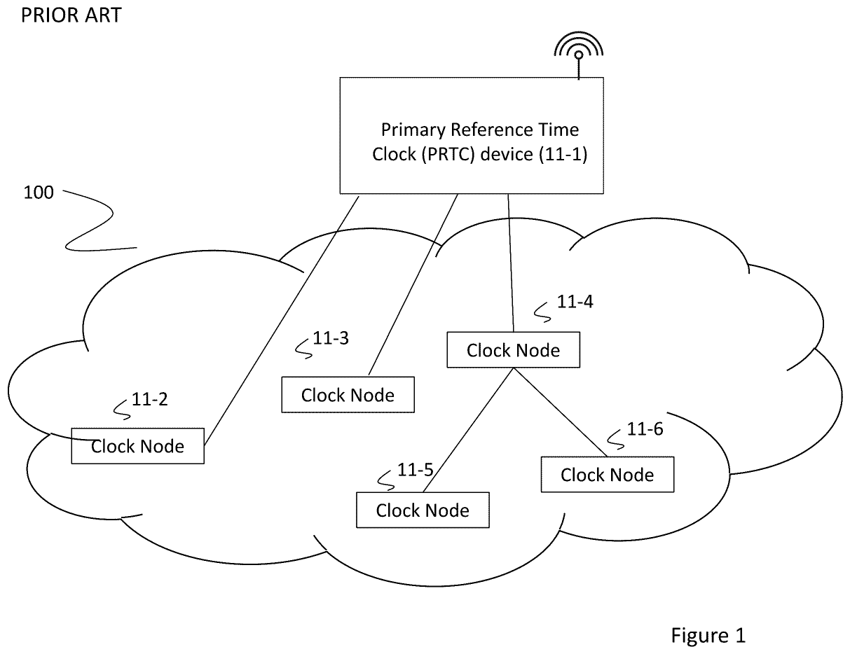

FIG. 2 illustrates a generalized block diagram of a clock device in accordance with certain embodiments of the presently disclosed subject matter;

FIG. 3 illustrates a schematic diagram of a holdover operation of the clock device in accordance with certain embodiments of the presently disclosed subject matter;

FIG. 4 illustrates a generalized flow chart of operating the clock device during timing holdover period in accordance with certain embodiments of the presently disclosed subject matter;

FIG. 5 illustrates a schematical presentation of holdover accuracy and stability achievable when operating in accordance with certain embodiments of the presently disclosed subject matter; and

FIG. 6 illustrates a generalized flow chart of obtaining history-based thresholds in accordance with certain embodiments of the presently disclosed subject matter.

### DETAILED DESCRIPTION

In the following detailed description, numerous specific details are set forth to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

It is to be understood that the term “signal” used herein excludes transitory propagating signals but includes any other signal suitable for the presently disclosed subject matter.

Unless specifically stated otherwise, throughout the specification the terms “continuously tuning”, “continuously processing”, “continuously learning”, “continuously generating” or the like refer to actions performed based on the availability of new data according to a certain arrangement. For example, such actions can be executed whenever new relevant data become available.

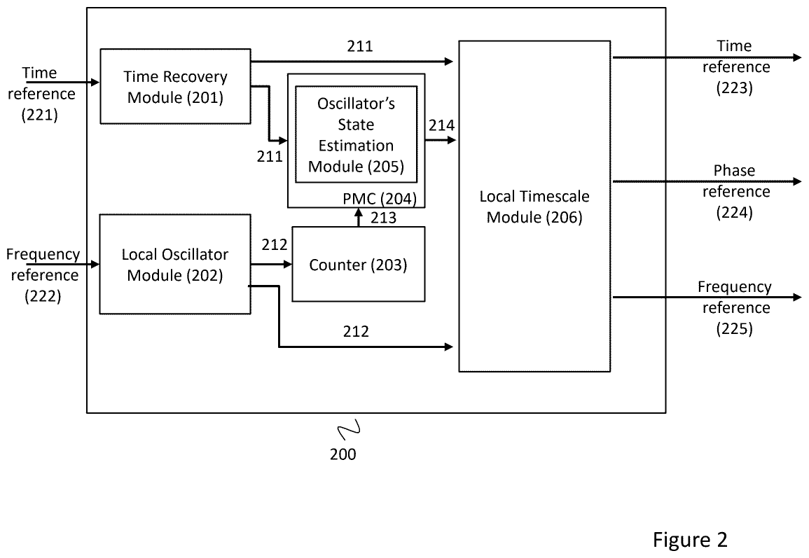

Bearing this in mind, attention is drawn to FIG. 2 illustrating a generalized block diagram of a clock device in accordance with certain embodiments of the presently disclosed subject matter.

A clock device 200 is configured to receive a reference timing signal 221 (e.g. from a GNSS signal or via PTP messaging) informative of timestamps and metadata defined by the appropriate standard(s). Time recovery module 201 is configured to process the received reference timing signal 221 (referred to hereinafter also as time reference 221) to reconstruct and maintain a synchronized time reference, and to send to a local timescale module 206 a signal 211 informative of the restored time/phase. Time recovery module 201 is further configured to send, in parallel, signal 211 to an oscillator's state estimation module (OSEM) 205 configured to run on a processing and memory circuitry (PMC) 204.

Clock device 200 comprises oscillator module 202. Oscillator module 202 is configured to send to a local timescale module 206 and to a counter 203 a signal 212 informative of its frequency.

For purpose of illustration only, the following description is provided for oscillator module 202 comprising an internal free running oscillator (not shown separately for the simplicity of illustration). Those skilled in the art will readily appreciate that the teachings of the presently disclosed subject matter are, likewise, applicable when oscillator module 202 comprises a controlled oscillator and/or works in conjunction with an external oscillator (e.g. atomic clock) providing a frequency reference signal 222.

Counter 203 is configured to continuously process signal 212 to count the phase based on the respective frequency. Counter 203 further continuously forwards the results 213 to OSEM 205.

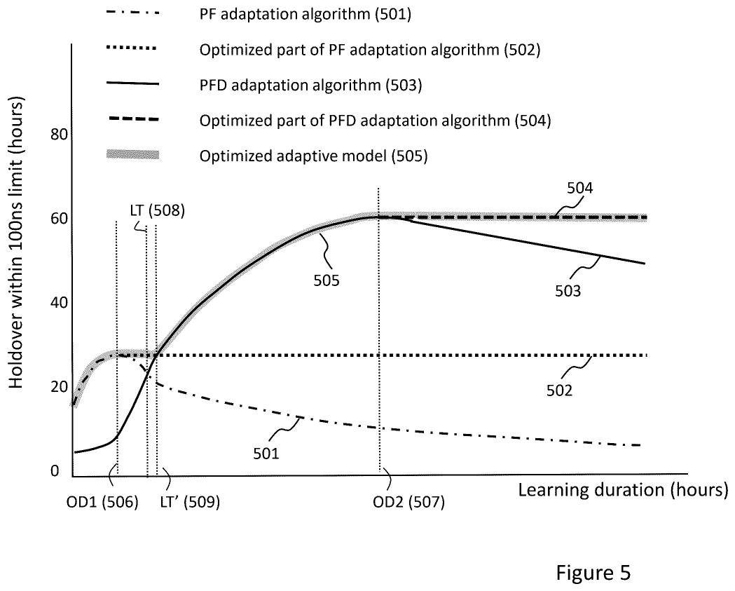

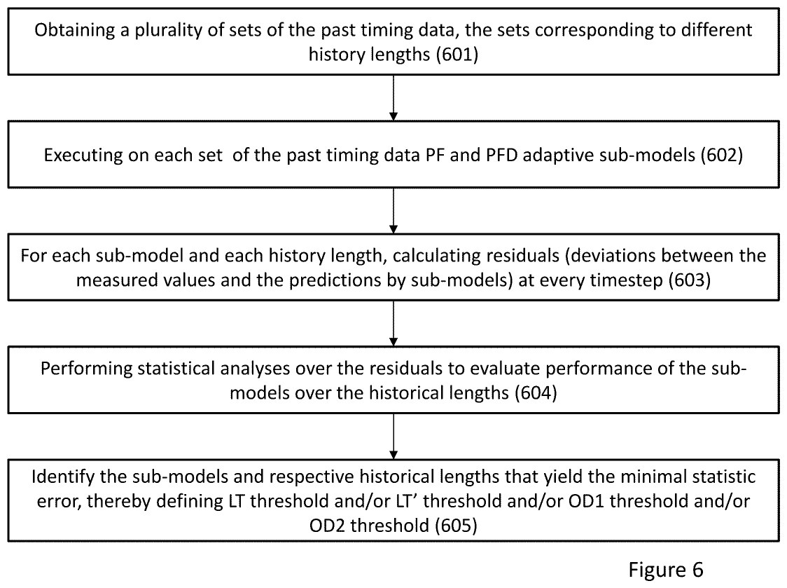

OSEM 205 is configured to continuously learn and calculate the state variables of the local oscillator in the presence of reference timing signal. OSEM 205 continues learning whenever time reference 221 is accessible. Optionally, the learning can be optimized to satisfy certain criteria as further detailed with reference to FIGS. 5-6.

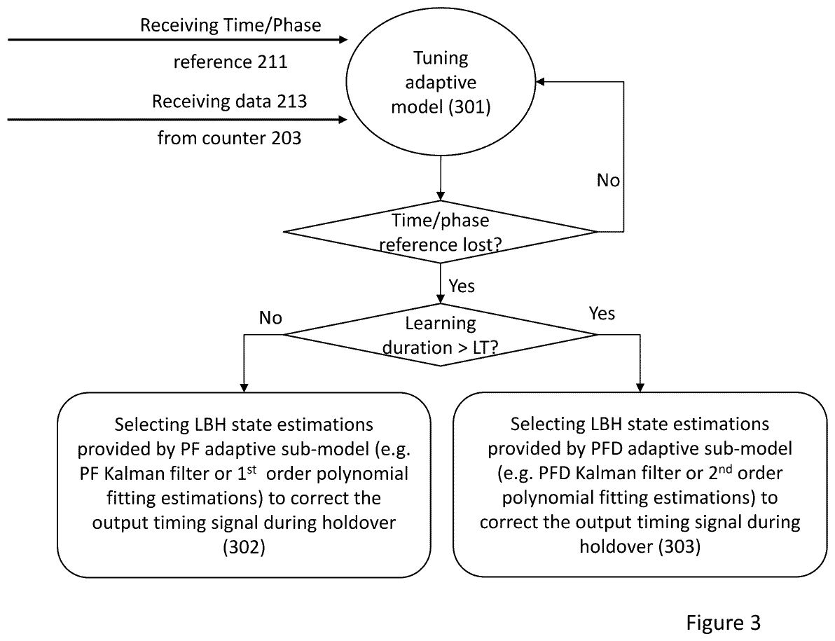

In the absence of time reference 221, OSEM 205 enables accurate timekeeping by leveraging the previously estimated variables of the oscillator's state as will be further detailed with reference to FIGS. 3-5. OSEM 205 is further configured to send to local timescale module 206 a timing signal 214 informative of the estimated phase and frequency offsets or estimated phase and frequency offsets and the drift.

Local timescale module 206 is configured to provide time keeping based on internal signals 211 and 212 in the presence of time reference and on internal signals 214 and 212 during holdover period. It is noted that signal 212 is provided by the free-running oscillator, and signal 214 provides the corrections made on top of the free-running oscillator.

Local timescale module 206 is further configured to generate outbound timing signals informative of outbound time reference 223, outbound phase reference 224 and outbound frequency reference 225.

It is noted that the teachings of the presently disclosed subject matter are not bound by the embodiments described with reference to FIG. 2. Equivalent and/or modified functionality can be consolidated or divided in another manner and can be implemented in any appropriate combination of software with firmware and/or hardware.

It is also noted that the source of the reference timing signal is not bound by GNSS. Those skilled in the art will readily appreciate that the teachings of the presently disclosed subject matter are, likewise, applicable to any other appropriate source including any other suitable satellite constellation (e.g. STL (Satellite Time and Location), an atomic clock, a data network, etc.).

Referring to FIG. 3, there is illustrated a schematic diagram of operating the clock device during the holdover in accordance with certain embodiments of the presently disclosed subject matter.

OSEM 205 receives restored time/phase reference 211 and data 213 informative of the oscillator's frequency and phase. In the presence of time reference 221, OSEM 205 uses the incoming measurements and observations to tune an adaptive model 301 maintained therein, and thus continuously adapts its estimates of the oscillator's state during the entire duration of the respective learning period. In accordance with certain embodiments of the presently disclosed subject matter, adaptive model 301 comprises a phase-frequency (PF) adaptive sub-model and phase-frequency-drift (PFD) adaptive sub-model, both sub-models are continuously tuned during the learning period and continuously provide estimates of a state of the oscillator.

It is noted that the term “tuning the adaptive model” should be expansively construed to cover tuning, at each given point-in-time, at least one sub-model.

It is further noted that unless specifically stated otherwise, the term “during a period” should be expansively construed to cover a time interval within said period without implying that it covers the whole duration of the period.

Responsive to the loss of external time reference 221 and, accordingly, restored time/phase reference 211, OSEM 205 uses the obtained last before holdover (LBH) estimates of the oscillator's state to enable continuously generating a corrected output timing signal.

OSEM 205 selects the adaptive sub-model whose LBH estimates to be used for further correcting the output timing signal during holdover, such sub-model being referred to hereinafter as “selected sub-model”. The selection is provided in accordance with the relationship between duration of the learning period and a learning threshold (such relationship is referred to hereinafter as learning criteria). Namely, when the duration of the learning period is less than the learning threshold, OSEM 205 selects (302) a phase-frequency (2-variables) adaptive sub-model and enables corrections of the output timing signal using the LBH state estimates (i.e. phase and frequency) provided by the PF sub-model. When/if the duration of the learning period exceeds the learning threshold, OSEM 205 selects (303) a phase-frequency-drift (3-variables) adaptive sub-model and enables corrections of the output timing signal using the LBH state estimates by PFD sub-model (i.e. phase, frequency and drift).

There are various ways to select a sub-model whose LBH estimates to be used for further processing. Selecting can be provided responsive to the loss of the reference timing signal or prior to the holdover.

For example, in certain embodiments both sub-models, in parallel, can be continuously tuned and can obtain estimates of the oscillator's state during the entire learning period. In such embodiments, upon loss of the reference timing signal, OSEM 205 uses the learning criteria to select LBH estimates to be used, thereby selecting the appropriate sub-model.

In other exemplified embodiments, OSEM 205 can use the learning criteria to select the sub-model(s) to run during certain time intervals of the learning period. For example, both sub-models can run when learning period is less than the learning threshold or, optionally, PFD sub-model can start running later (e.g. a certain duration before the learning threshold is reached or responsive to reaching the learning threshold). In both options, OSEM 205 can stop running PF model when the learning period exceeds the learning threshold. Thus, OSEM 205 selects PF sub-model for LBH estimates even if PFD model runs before the learning threshold and selects PFD sub-model as the only sub-model running when learning period exceeds the learning threshold.

It is noted that in certain embodiments selection of a sub-model and/or calculating the respective offsets (and drift when relevant) can be provided by local timescale module 206.

In certain embodiments, the learning threshold can be predefined in accordance with known characteristics of the oscillator (e.g. maximal time error, aging, Allan Variance and deviation thereof, etc.). In other embodiments, the learning threshold can be calculated (e.g. by OSEM 205) based on historical data informative of phase and frequency changes of the local oscillator during its operation prior to the holdover. Non-limiting examples of defining the learning thresholds are further detailed with reference to FIGS. 5-6.

It is noted that the duration of the learning period and the learning thresholds can be expressed in the units of time and/or number of iterations.

The adaptive algorithms used in the adaptive sub-models are configured to estimate the state of the free-running oscillator based on incoming measurements and predictions.

By way of non-limiting example, 2-variables (phase-frequency) adaptive sub-model can be based on 1^{st} order polynomial fitting estimations algorithm fitting data points to a linear model. In other embodiments, the 2-variables adaptive sub-model can be based on a phase-frequency Kalman filter algorithm. Phase-frequency (PF) Kalman filter is configured to jointly estimate both phase and frequency of the oscillator considering the correlations between phase and frequency variations.

By way of another non-limiting example, the 3-variables (phase-frequency-drift) adaptive sub-model can be based on 2^{nd} order polynomial fitting estimations algorithm. The sub-model can involve fitting a second-order polynomial function to the data points by minimizing the sum of the squared differences between the reference timing signal and the internal/external oscillator. In other embodiments, the 3-variables adaptive sub-model can be based on phase-frequency-drift Kalman filter algorithm. Phase-frequency-drift (PFD) Kalman filter is configured to jointly estimate phase, frequency and drift of the oscillator.

Those skilled in the art will readily appreciate that the teachings of the presently disclosed subject matter are, likewise, applicable to any other adaptive models combining 2-variables (phase-frequency) adaptive sub-models with a 3-variables (phase-frequency-drift) sub-model as disclosed above.

It is noted that the adaptive model can include a 2-variables sub-model and a 3-variables sub-model based on the same or on different kinds of algorithms. By way of non-limiting example, the 2-variables sub-model can be based on a PF Kalman filter while the 3-variables sub-model can be based on 2^{nd} order polynomial fitting estimations (and vice versa).

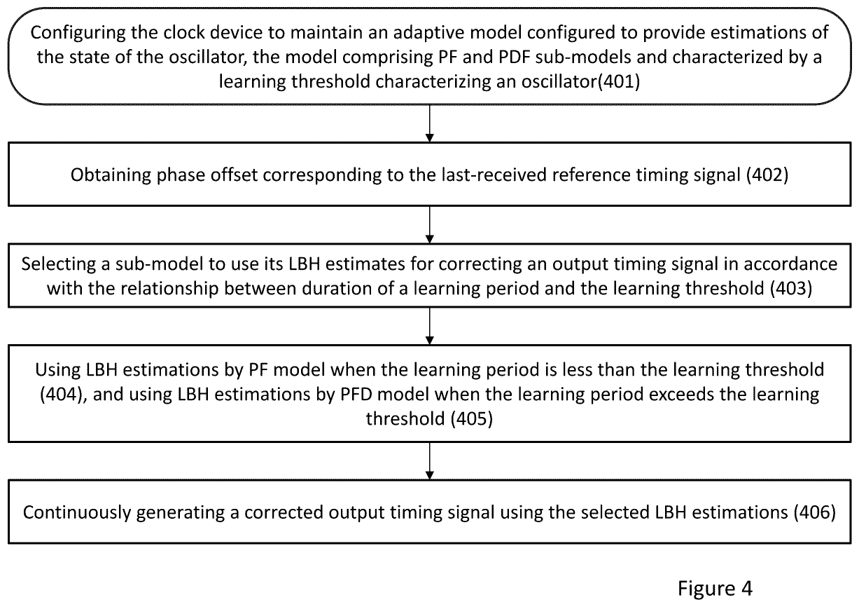

The generalized flow chart of operating the clock device during timing holdover period is further illustrated in FIG. 4.

Clock device 200 is configured to maintain (401) (e.g. in OSEM 205) an adaptive model comprising PF and PFD sub-models and characterized by the learning threshold depending on characteristics of the oscillator. Maintaining the adaptive model comprises continuously tuning at least one of the sub-models during the learning period and continuously providing estimates of the oscillator's state in the presence of the time reference. In certain embodiments, the learning threshold can be pre-configured in accordance with a predefined value. In other embodiments, clock device 200 can calculate and configure the learning threshold when operating in the presence of the time reference. As further detailed in FIG. 6, the learning threshold can be calculated based on historical data informative of state variables of the oscillator prior to the holdover.

Upon loss of time/phase reference, clock device 200 (e.g. OSEM 205) obtains (402) the phase offset corresponding to the last-received reference timing signal. In certain embodiments, OSEM 205 can continuously receive signal 211 informative of the restored time/phase and, thus, be aware of the respective last-received data. In other embodiments, the respective last-received data can be sent to OSEM 205 responsive to the loss of reference timing signal.

Responsive to the loss of the reference timing signal, clock device 200 uses the LBH state estimates by the adaptive model to continuously generate (406) a corrected output timing signal informative of time, frequency and phase references (e.g. denoted as 223, 224, 225 in FIG. 2).

Prior to using said state estimates during the holdover, clock device 200 selects (403) a sub-model in accordance with the relationship between duration of the learning period and a learning threshold. Namely, the clock device selects to use (404) the estimates of frequency offset by the phase-frequency adaptive sub-model when the learning period is less than the learning threshold, and selects to use (405) the estimates of frequency offset and drift by a phase-frequency-drift adaptive sub-model when the learning period exceeds the learning threshold.

It is noted that in certain embodiments operations 403-405 are provided in the presence of reference timing signal, and in other embodiments said operations are provided responsive to the loss of reference timing signal.

When using PF model, phase offset Δφ(t) is calculated as Δφ(t)=Δφ(0)+Δf*t, and when using PFD model, phase offset Δφ(t) is calculated as

$$Δφ ( t ) = Δφ ( 0 ) + Δ {f}^{*} t + 0.5 ( \frac{d Δ f}{d t} ) * {t}^{2} ,$$

where Aφ(0) is the phase offset last received from the reference timing signal, Δf is the calculated frequency offset and t is the elapsed time.

FIG. 5 schematically presents holdover accuracy and stability achievable when operating in accordance with certain embodiments of the presently disclosed subject matter.

Curve 501 represents the dependency between the accuracy and the stability during holdover and the duration of the learning period (X-axis) of the respectively applied PF adaptive algorithm. By way of non-limiting example, accuracy and stability during holdover is represented by duration of holdover with the required accuracy (Y-axis).

Likewise, curve 503 represents the dependency between the accuracy/stability during holdover and the duration of learning period of applied PFD adaptive algorithm. As illustrated, when the learning period is short, using estimates by the PF adaptive algorithm provides better results than by the PFD adaptive algorithm. However, when the learning period exceeds learning threshold (LT) 508, using estimates by PFD algorithm provides better results than by PF algorithm.

Thus, in accordance with certain embodiments of the presently disclosed subject matter, the accuracy/stability can be improved by using estimates by PF sub-model when learning period is less than LT 508 and using estimates by PFD sub-model when learning period exceeds LT 508.

It is noted that the value of the learning threshold can depend on certain adaptation algorithms implemented in PF and PFD sub-models.

Further to the above, the inventor has recognized and appreciated that increasing the duration of the learning history can lead to degradation of adaptive algorithms. For example, due to temperature changes affecting the oscillator and/or nonlinear changes in drift, its state variables' behavior may change over time and too old historical data may become irrelevant for estimations.

Thus, to optimize a given adaptive algorithm, the inventor has proposed the following:
define, for the given adaptive algorithm, an optimal duration of learning history and a respective optimal duration (OD) threshold;
for learning periods exceeding the optimal duration threshold, provide continuously tuning the given adaptation algorithm in accordance with state variables corresponding to a continuously sliding backward window with duration equal to the optimal duration and starting point at the OD threshold.

As illustrated in FIG. 5, the maximum of effectiveness of a regular PF algorithm (curve 501) corresponds to a learning period defined by a first optimal duration (OD1) threshold 506, and curve 502 illustrates effectiveness of the PF algorithm optimized for learning period exceeding OD1. Likewise, maximum of effectiveness of regular PFD algorithm (curve 503) corresponds to learning period defined by a second optimal duration threshold (OD2) 507, and curve 504 illustrates effectiveness of the PFD algorithm optimized for learning period exceeding OD2 507.

In the illustrated case of optimized PF and PFD adaptive algorithms, PFD optimized algorithm becomes more effective than PF optimized algorithm for learning periods exceeding the learning threshold LT′ 509.

Curve 505 represents the optimized holdover accuracy and stability achievable by the combined adaptive model.

Thus, in accordance with certain embodiments of the currently presented subject matter, operating the oscillator during the holdover can be optimized as following:
PF sub-model to be used when duration of the learning period is less than LT′ 509, wherein:
when learning period is less than OD1 threshold, PF algorithm is tuned based on entire available learning history; and
when learning period exceeds OD1 threshold, PF algorithm is tuned based on the learning history corresponding, at each timestep, to data in a backward window with duration OD1;
PFD sub-model to be used when duration of the learning period exceeds LT′ 509, wherein:
when learning period is less than OD2 threshold, PFD algorithm is tuned based on entire available learning history; and
when learning period exceeds OD2 threshold, PFD algorithm is tuned based on the learning history corresponding, at each timestep, to data in a backward window with duration OD2.

By way of non-limiting examples, the values of the thresholds can be in the order of few days or even tens of days for the clock devices using such accurate frequency reference as a Cesium clock, and can be in order of few hours or few days for the clock devices using less accurate frequency references, such as a TCXO (Temperature-Compensated Crystal Oscillator), or OCXO (Oven Controlled Crystal Oscillator) or Rubidium clock.

OD1 and OD2 thresholds are informative of respective optimal learning durations, and LT and LT′ thresholds are informative of the threshold for selecting the sub-models in, respectively, the cases with non-optimized and the optimized learning duration.

In certain embodiments, the values of the thresholds can be obtained by a simulation based on a specification of a given oscillator. For example, simulating the thresholds can include the following steps:
pre-determining values of frequency offset and drift;
estimating frequency offset and drift with PF and PFD sub-models, while considering the frequency stability characteristics of the clock, characterized by the Allan Variance specified for the given oscillator;
simulating the holdover performance by using the residuals of the pre-determined frequency offset and drift and the estimated ones; and
using the simulation results to set the values of LT, LT′, OD1 and/or OD2.

FIG. 6 illustrates a generalized flow chart of obtaining history-based thresholds (LT, LT′, OD1 and/or OD2). In accordance with certain embodiments of the presently disclosed subject matter, clock device 200 can be configured to store values (e.g. in PMC 204) informative of time/phase and frequency restored during operating the clock device in the presence of the reference timing signal (such values are referred to hereinafter as “past timing data”).

Clock device 200 (e.g. PMC 204) obtains (601) a plurality of sets of the past timing data, different sets corresponding to different history lengths. Clock device 200 applies phase-frequency (PF) and phase-frequency-drift (PFD) adaptive sub-models (602) for each set of the past timing data.

For each sub-model and each history length, clock device 200 calculates (603) residuals for every timestep. The term “residuals” refers to deviations between the past timing data and the respective predictions by the sub-models. The term “timestep” refers to the interval at which the clock updates its state and/or measurements.

Clock device 200 (e.g. PMC 204) performs statistical analyses over the residuals to evaluate (604) performance of the sub-models over the respective historical lengths. Further the clock device identifies the sub-models and respective historical lengths that yields the minimal statistic error, thereby defining (605) the respective learning threshold for switching between the sub-models. Likewise, the clock device identifies for each sub-model the optimal learning duration, thereby defining OD1 and OD2 thresholds.

It is noted that above history-based analyses can be provided for different pairs of PF and PFD models, thereby enabling selection of the pair best fitting timekeeping criteria and setting the respective thresholds thereof.

It is further noted that the teaching above are, likewise, applicable for holdover period of a clock device operating with a controlled oscillator.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A method of timekeeping of a clock device operating in conjunction with an oscillator, the method comprising:
in the presence of an inbound reference timing signal, continuously tuning during a learning period an adaptive model comprising a phase-frequency (PF) adaptive sub-model using a PF adaptive algorithm and a phase-frequency-drift (PFD) adaptive sub-model using a PFD adaptive algorithm, both sub-models;
selecting a sub-model to use for correcting an output timing signal during a holdover, the selection provided in accordance with the relationship between duration of the learning period and a learning threshold characterizing the oscillator, wherein the selection is provided in the presence of the inbound reference timing signal or responsive to a lost thereof; and
during the holdover period, continuously generating a corrected output timing signal using the last before holdover (LBH) estimates provided by the selected sub-model.

2. The method of claim 1 further comprising:
when a duration of the learning period is less than the learning threshold, using LBH estimates of phase and frequency of the oscillator provided by the PF adaptive sub-model; and
when the duration of the learning period exceeds the learning threshold, using LBH estimates of phase, frequency and drift of the oscillator provided by the PFD adaptive sub-model.

3. The method of claim 1, wherein the learning threshold is predefined with the help of simulation using known characteristics of the oscillator and is pre-configured for the clock device.

4. The method of claim 1, wherein the learning threshold is calculated based on historical data informative of phase and frequency changes of the oscillator during its operation in the presence of inbound reference timing signal and is further configured during operation of the clock device in the presence of the inbound reference timing signal.

5. The method of claim 1, wherein the oscillator operating in conjunction with the clock device is an internal oscillator of the clock device or an external oscillator.

6. The method of claim 1, wherein the oscillator operating in conjunction with the clock device is a free running oscillator or a controlled oscillator.

7. The method of claim 1, wherein the PF adaptive sub-model uses a 1^{st} order polynomial fitting estimations algorithm or a phase-frequency Kalman filter algorithm and wherein PFD adaptive sub-model uses a 2^{nd} order polynomial fitting estimations algorithm or a phase-frequency-drift Kalman filter algorithm.

8. The method of claim 1, wherein the PF adaptive sub-model and PFD adaptive sub-model are based on the same or on different kinds of algorithms.

9. The method of claim 1, further comprising:
storing values informative of time/phase and frequency restored during operating the clock device in the presence of the reference timing signal thereby giving rise to past timing data;
obtaining a plurality of sets of the past timing data, different sets corresponding to different history lengths;
applying one or more phase-frequency adaption algorithms and one or more phase-frequency-drift adaption algorithm for each set of the past timing data;
calculating, for each adaptive algorithm, for each history length and for every timestep, residuals informative of deviations between respective past timing data and predictions by the adaptive algorithms; and
performing statistical analyses over the residuals to identify an optimal duration of learning period for each of the adaptive algorithms, thereby defining the learning threshold.

10. The method of claim 1, further comprising defining a first optimal duration (OD1) threshold informative of the optimal duration of tuning a phase-frequency adaptive algorithm used in PF adaptive sub-model and/or a second optimal duration (OD2) threshold informative of the optimal duration of a phase-frequency-drift adaptive algorithm used in PFD adaptive sub-model.

11. The method of claim 10, further comprising:
using the estimates by the PF sub-model when the duration of the learning period is less than the learning threshold, wherein:
when the learning period is less than the OD1 threshold, using the estimates by the PF sub-model that is tuned based on entire available learning history; and
when learning period exceeds OD1 threshold, using the estimates by the PF sub-model that is tuned based on the learning history corresponding, at each timestep, to data in a backward window with duration OD1;
using the estimates by the PFD sub-model when duration of the learning period exceeds the learning threshold, wherein:
when learning period is less than OD2 threshold, using the estimates by the PFD sub-model that is tuned based on entire available learning history; and
when learning period exceeds OD2 threshold, using the estimates by the PFD sub-model that is tuned based on the learning history corresponding, at each timestep, to data in a backward window with duration OD2.

12. A clock device configured to operate in conjunction with an oscillator and comprising a processor and memory circuitry (PMC), wherein the PMC is configured to:
in the presence of an inbound reference timing signal, continuously tune during a learning period an adaptive model comprising a phase-frequency (PF) adaptive sub-model using a PF adaptive algorithm and a phase-frequency-drift (PFD) adaptive sub-model using a PFD adaptive algorithm, both sub-models;
select a sub-model to use for correcting an output timing signal during a holdover, the selection provided in accordance with the relationship between duration of the learning period and a learning threshold characterizing the oscillator, wherein the selection is provided in the presence of the inbound reference timing signal or responsive to a lost thereof; and
during the holdover period, continuously generate a corrected output timing signal using the last before holdover (LBH) estimates provided by the selected sub-model.

13. The clock device of claim 12 further configured to:
when a duration of the learning period is less than the learning threshold, use LBH estimates of phase and frequency of the oscillator provided by the PF adaptive sub-model; and
when the duration of the learning period exceeds the learning threshold, use LBH estimates of phase, frequency and drift of the oscillator provided by the PFD adaptive sub-model.

14. The clock device of claim 12, wherein the learning threshold is predefined with the help of simulation using known characteristics of the oscillator and is pre-configured for the clock device.

15. The clock device of claim 12, wherein the learning threshold is calculated based on historical data informative of phase and frequency changes of the oscillator during its operation in the presence of inbound reference timing signal and is further configured during operation of the clock device in the presence of the inbound reference timing signal.

16. The clock device of claim 12, wherein the oscillator operating in conjunction with the clock device is an internal oscillator of the clock device or an external oscillator.

17. The clock device of claim 12, wherein the oscillator operating in conjunction with the clock device is a free running oscillator or a controlled oscillator.

18. The clock device of claim 12, wherein the PMC is further configured to define a first optimal duration (OD1) threshold informative of the optimal duration of tuning a phase-frequency adaptive algorithm used in PF adaptive sub-model and/or a second optimal duration (OD2) threshold informative of the optimal duration of a phase-frequency-drift adaptive algorithm used in PFD adaptive sub-model.

19. The clock device of claim 12, wherein the PMC is further configured to:
use the estimates by the PF sub-model when the duration of the learning period is less than the learning threshold, wherein:
when the learning period is less than the OD1 threshold, use the estimates by the PF sub-model that is tuned based on entire available learning history; and
when learning period exceeds OD1 threshold, use the estimates by the PF sub-model that is tuned based on the learning history corresponding, at each timestep, to data in a backward window with duration OD1;
use the estimates by the PFD sub-model when duration of the learning period exceeds the learning threshold, wherein:
when learning period is less than OD2 threshold, use the estimates by the PFD sub-model that is tuned based on entire available learning history; and
when learning period exceeds OD2 threshold, use the estimates by the PFD sub-model that is tuned based on the learning history corresponding, at each timestep, to data in a backward window with duration OD2.

20. A non-transitory computer readable medium usable by a clock device operating in conjunction with an oscillator, the computer readable medium comprising instructions that, when executed by a processor and memory circuitry (PMC) comprised in the clock device, cause the PMC to perform operations comprising:
in the presence of an inbound reference timing signal, continuously tuning during a learning period an adaptive model comprising a phase-frequency (PF) adaptive sub-model using a PF adaptive algorithm and a phase-frequency-drift (PFD) adaptive sub-model using a PFD adaptive algorithm, both sub-models;
selecting a sub-model to use for correcting an output timing signal during a holdover, the selection provided in accordance with the relationship between duration of the learning period and a learning threshold characterizing the oscillator, wherein the selection is provided in the presence of the inbound reference timing signal or responsive to a lost thereof; and
during the holdover period, continuously generating a corrected output timing signal using the last before holdover (LBH) estimates provided by the selected sub-model.
